(19) United States
(12) Patent Application Publication
(10) Pub. No.: US 2004/0043640 A1
(43) Pub. Date: Mar. 4, 2004

(54) High density interconnect

(76) Inventors: Bob J. Self, Colorado Springs, CO (US); Donald M. Logelin, Colorado Springs, CO (US); Robert H. Wardwell, Colorado Springs, CO (US)

Correspondence Address: AGILENT TECHNOLOGIES, INC., Legal Department, DL429, Intellectual Property Administration, P.O. Box 7599, Loveland, CO, 80537-0599, US

(21) Appl. No.: 10/232,800

(22) Filed: Aug. 30, 2002

(51) Int. Cl. H01R 12/00

(52) U.S. Cl. 439/66

(57) ABSTRACT

An interconnect having a stiff layer, such as a PCB, having a plurality of holes therein. A first flexible layer is bonded to a first side of the stiff layer, the first flexible layer having a plurality of conductive bumps thereon positioned over holes. A second flexible layer is bonded to a second side of the stiff layer, the second flexible layer having a plurality of conductive bumps thereon positioned over holes. Vias connect the plurality of conductive bumps on the first layer to the plurality of conductive bumps on the second layer.

### BACKGROUND OF THE INVENTION

Many test and measurement devices, including logic analysis systems and probes, require the use of a high density interconnect to interface with a device under test. In the case of a logic analysis probe that tests circuits secured by, for example a ball grid array, it is not unusual for a logic analysis probe to use an interconnect having a 49×49 array of connections to connect the probe to the board under test. Such interconnects have a total of 2,401 connections. Many current interconnects are of the so-called “bed of nails” variety that is clamped over a matrix of lands, for example to the rear of a ball grid array, formed on a board under test. In this configuration, the connections (e.g. the nails) match with the lands on the board. Known interconnects of this configuration require a clamping force of 40 to 60 grams per contact meaning that over 96 Kilograms (up to 144 Kilograms) of clamping force is required. Other known types of interconnects include socketing and a variety of board to board interconnects most of which have similar clamping requirements.

Examples of known interconnects include those produced by INTERCON SYSTEMS, SHINETSU, TYCO, TELADYNE, and PARACON for use with their respective probe offerings. The probes provided by such producers often include additional circuitry to perform specialized functions including: pin translation, termination, and compensation. In these probes, the additional circuitry is either added to the test and measurement unit or embedded in an additional structure associated with the cable. While useful, such additional circuitry would benefit from being integrated with the interconnect. Such integration would lead to decreased loads and reduced stub lengths.

Accordingly, the present inventors have recognized a need for interconnects that reduce the required clamping force while providing for integrated circuitry.

### BRIEF DESCRIPTION OF THE DRAWINGS

An understanding of the present invention can be gained from the following detailed description of the invention, taken in conjunction with the accompanying drawings of which:

FIG. 1 is a cross-sectional view of a connection in accordance with a preferred embodiment of the present invention.

FIG. 2 is a cross-sectional view of a connection, as shown in FIG. 1, in situ in accordance with a preferred embodiment of the present invention

FIG. 3 is a plan view of an interconnect in accordance with a preferred embodiment of the present invention.

FIG. 4 is a cross-sectional view of a connection, in accordance with a preferred embodiment of the present invention, taken along line A-A in FIG. 3.

FIG. 5 is a cross-sectional view of an interconnect, in accordance with a preferred embodiment of the present invention, taken along line B-B in FIG. 3.

FIG. 6 is a cross-sectional view of a connection in accordance with another preferred embodiment of the present invention.

### DETAILED DESCRIPTION

Reference will now be made in detail to the present invention, examples of which are illustrated in the accompanying drawings, wherein like reference numerals refer to like elements throughout.

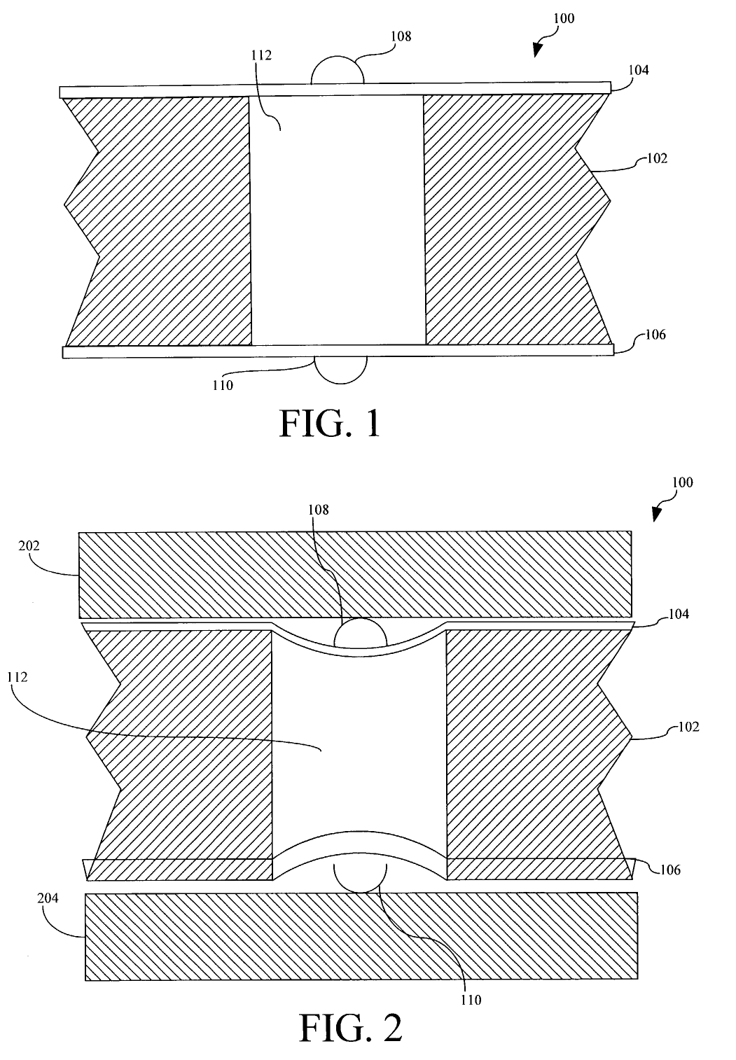

FIG. 1 is a cross-sectional view of a connection 100 in accordance with a preferred embodiment of the present invention. It will be appreciated by those of ordinary skill in the relevant arts that the connection 100, as illustrated in FIG. 1, and the operation thereof as described hereinafter is intended to be generally representative such connections and that any particular connection may differ significantly from that shown in FIG. 1, particularly in the details of construction of such interconnect, while still falling within the scope of the invention. As such, the connection 100 is to be regarded as illustrative and exemplary and not limiting as regards the invention described herein or the claims attached hereto.

The connection 100 is formed on a printed circuit board (PCB) 102, comprising for example FR-4. Flexible layers 104 and 106 are bonded to a first and second side of the PCB 102. The flexible layers are preferably formed of Capton and act, in effect, as flexible circuit boards. A pair of conductive bumps 108 and 110 are formed on the flexible layers 104 and 106, respectively, over a hole 112 in the PCB 102. The bumps 108 and 110 are preferably formed of gold, but any suitable conductive material may be used such as copper. The bumps 108 and 110 are connected using vias (not shown in FIG. 1) formed to electrically connect the flexible layers 104 and 106 through the PCB 102. Usually, but not always, vias are formed by drilling a hole through the PCB 102 and the flexible layers 104 and 106 and depositing conductive material, such as gold or copper, into the hole.

FIG. 2 is a cross-sectional view of the connection 100, as shown in FIG. 1, in situ in accordance with a preferred embodiment of the present invention. More specifically, FIG. 2, shows the connection 100 interposed between a first board 202 (for example a connector on a probe) and a second board 204 (for example a circuit under test). The flexible layers 104 and 106 are flexed toward the center of the PCB 102 into the hole 112. It is anticipated that the clamping force required will be in the range of 20 to 25 grams per connector. Thus, in a 49×49 array of 2,401 connections no more that 60 Kilograms of clamping force should be required.

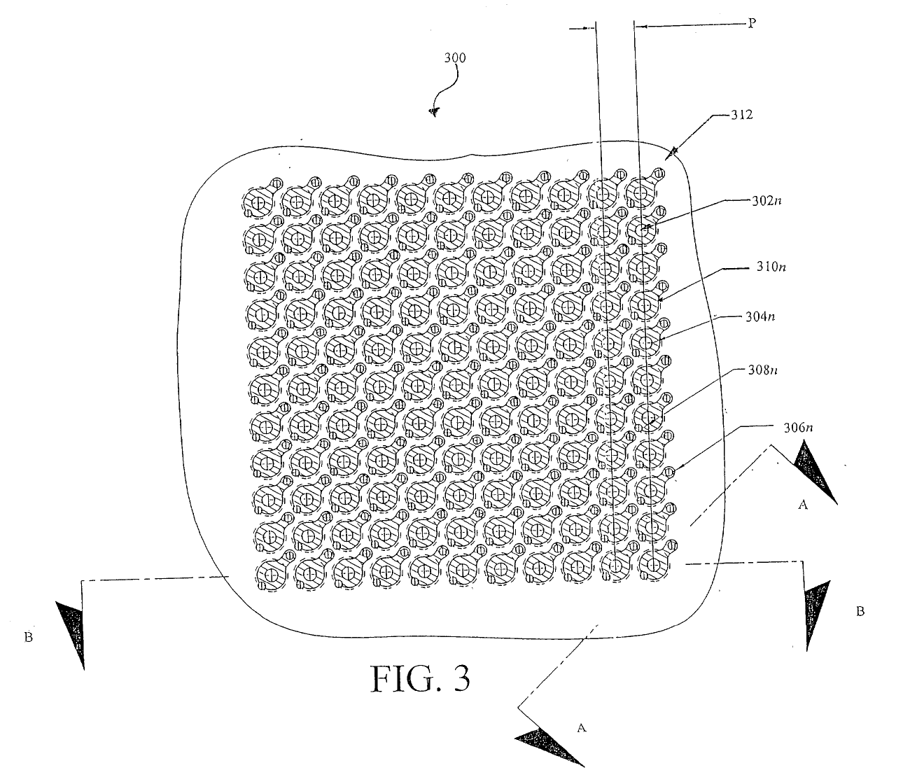

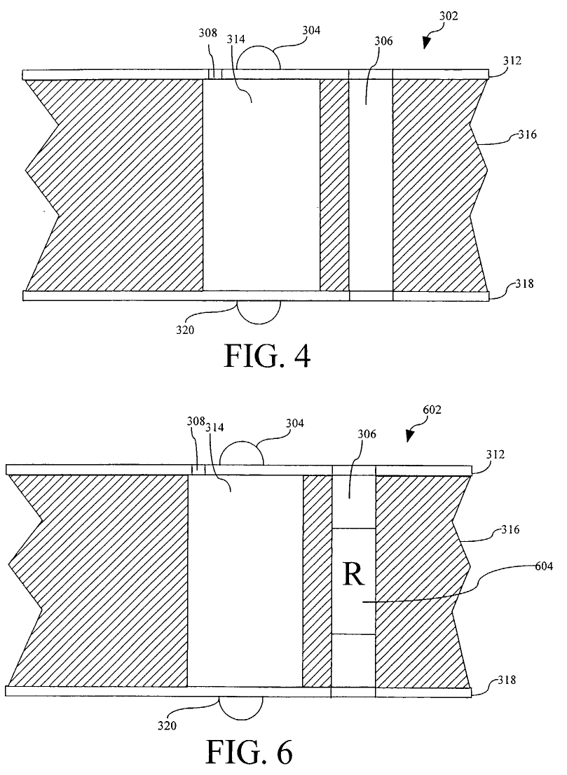

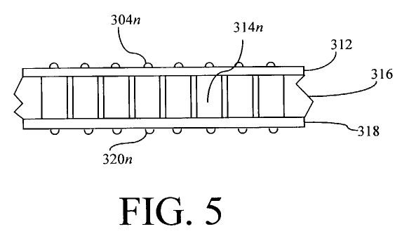

FIG. 3 is a plan view of an interconnect 300 in accordance with a preferred embodiment of the present invention. FIG. 3 shows an 11×11 array of connections 302n. Each connection comprises conductive bumps 304n (along with opposing bumps on the other side of the interconnect 300—not shown), vias 306n, and vents 308n. The vias 306n are connected to the bumps 304n by tracings 310n on the flexible layer 312. The opposing bumps 320n (see FIGS. 4 and 5) are similarly connected with tracing on the flexible layer 318 (see FIGS. 4 and 5). The vias 306n are preferably placed at 45 degrees to the grid of bumps 302n to allow for more efficient packing. It should be noted that it is possible, and maybe even desirable, to coat the hole 314n (see FIG. 4) with a conductor thereby forgoing the need for a separate signal feed 306n.

The vents 308n are provided to allow gas to escape the holes 112 during fabrication of the interconnect 300 and during compression in use. Depending on the fabrication method, the vent holes 308n may not be required.

FIG. 4 is a cross-sectional view of a connection 302, in accordance with a preferred embodiment of the present invention, taken along line A-A in FIG. 3. As set forth above, the connection 302 is formed on a PCB 316 layered with flexible layers 312 and 318. Bumps 304 and 320 are deposited on the flexible layers 312 & 318, respectively, over the hole 314. A via 306 electrically connects the bumps 304 and 320. A vent 308 (optional) is provided on the flexible layer 312 to permit gas to escape from the hole 314. Those of ordinary skill in the art will recognize that FIG. 4 shows one possible orientation of via 306, hole 314, and vent 308.

FIG. 5 is a cross-sectional view of the interconnect 300, in accordance with a preferred embodiment of the present invention, taken along line B-B in FIG. 3. The pitch between adjacent bumps 604n and/or adjacent bumps 320n may be adjusted to match the circuit under test, but could be as close as 1.00 mm or less

One process for the creation of an interconnect in accordance with the preferred embodiments of the present invention is set forth hereinafter. The process uses the following materials: sheet adhesive (such as the Dupont AP series); Capton (such as the Dupont LF series); PCB (such as Isola FR4); Dry Film Resist; and Silver Halide Film.

1. Shear adhesive, Capton and PCB materials relative to lamination plate dimensions.

2. Clean materials from step #1.

3. Set the adhesive and Capton materials aside in a desiccant chamber.

4. Drill air gap vias and tooling in PCB to specifications.

5. Coat Drilled PCB material with Dry Film Resist.

6. Photoplot and develop to provide targeting coupon information relative to drilled holes on the PCB material.

7. Using the Silver Halide Film, eye registered them to the drilling in the PCB material.

8. Print resist coated PCB.

9. Develop the resist coated PCB material.

10. Etch resist coated PCB material.

11. Strip resist coated PCB material.

12. Punch tooling holes in adhesive and Capton materials.

13. Place adhesive and PCB materials in Plasma Etch at 225° F. for 1 hour then plasma using Flex Press Prep Cycle.

14. Layup adhesive, Capton and PCB materials along with all other pertinent pressing materials.

15. Press at desired temperature followed by a 30 min cooling cycle under high pressure.

16. Drill conduction vias in panel with respect to etched targeting pattern.

17. Plate thru panel in conduction vias.

18. Panel plate the plated thru panel to a copper deposition thickness in the conduction vias.

19. Coat panel with Electrophoretic Resist.

20. Photoplot and develop according to specified artwork to provide land pads relative to drilled holes on the PCB material.

21. Using the Silver Halide Films, eye registered them to the drilling in the panel.

22. Print resist coated panel with Silver Halide films.

23. Develop resist-coated panel.

24. Etch resist-coated panel.

25. Strip resist coated panel.

26. Coat panel with 3 layers of Dry Film Resist.

27. Photoplot and develop according to specified artwork to provide plating image relative the land pads etched on the panel.

28. Using the Silver Halide Films, eye registered them to the land pads on the panel.

29. Print resist-coated panel.

30. Develop resist-coated panel.

31. Electroplate copper “Bumps” on the resist-coated panel at the relevant length of time, preferably at very low current.

32. Strip resist coated panel.

33. Coat panel with Dry Film Resist.

34. Photoplot and develop according to specified artwork to provide a post gold etch resist relative to the etched land pads on the panel.

35. Using the Silver Halide Films, eye registered them to the land pads.

36. Print resist coated panel with Silver Halide films.

37. Develop resist-coated panel.

38. Electrolytic Gold/Nickel-plate (Subcontract) with 25 uin of Gold over 250 uin of Nickel.

39. Strip resist coated panel.

40. Etch panel.

41. Final Route “Bump” boards from panel according to specified artwork and tolerances.

Although a few embodiments of the present invention have been shown and described, it would be appreciated by those skilled in the art that changes may be made in these embodiments without departing from the principles and spirit of the invention, the scope of which is defined in the claims and their equivalents. For example, the PCB 102 can be configured as a multi-layer circuit to facilitate pin translation. Also, while the printed circuit board 102 is described as having holes 112 which extend through the PCB 102, those of ordinary skill in the art will recognize that the holes 112 need not extend through the board. The holes 112, but need only be deep enough to contain the portions of the flexible layers (104 and 106) and the bumps (108 and 110) that are displaced when the interconnect 300 is in use. In such a configuration, it would be possible to use the non-perforated middle of the PCB as a signal layer for re-routing signals between bumps. It is also envisioned that other structures can be utilized instead of the PCB 102. Most any stiff structure, such as any number of ceramics, capable of bonding to the flexible layers 104 and 106 could be utilized.

One advantage of the present invention is that it facilitates the embedding of additional circuit components, such as resistors and capacitors to perform specialized functions, including pin translation, termination, and compensation. Such components can be incorporated by embedding them in the signal paths 306n of PCB 102, mounted on the flexible layers 312 and 318, or mounted to the PCB 316. Pin translation can be implemented by, for example, opening selected signal paths 306n or re-routing the tracings 310n.

FIG. 6 is a cross-sectional view of a connector 602 in accordance with another preferred embodiment of the present invention taken along line A-A in FIG. 3. FIG. 6 illustrates the embedding of components, in this case a resistor 604, in vias 306n. The present invention is particularly suited for the embedding of networks comprising: resistors (R); capacitors (C); and inductors (L). R, RC, and RCR networks may be formed and embedded into PCB 316 or surface mounted onto the PCB 316, the flexible layer 312 or the flexible layer 318.

Components, such as the resistor 604, can be embedded by placing the component, or components, into the holes used to form vias 306n, as in the previous description, and then filing the hole with solder. It may be desirable to select the thickness of the PCB102 to match that of the component to facilitate economical assembly. The use of a ceramic board instead of the PCB 316 may facilitate embedding.

What is claimed is:

1. An interconnect comprising:
a stiff layer having a plurality of holes therein;
a first flexible layer bonded to a first side of the stiff layer, the first flexible layer having a plurality of conductive bumps thereon positioned over holes;
a second flexible layer bonded to a second side of the stiff layer, the second flexible layer having a plurality of conductive bumps thereon positioned over holes; and
signal paths embedded in the stiff layer connecting the plurality of conductive bumps on the first layer to the plurality of conductive bumps on the second layer.

2. An interconnect, as set forth in claim 1, wherein the stiff layer comprises a printed circuit board.

3. An interconnect, as set forth in claim 1, wherein the stiff layer comprises FR-4.

4. An interconnect, as set forth in claim 1, wherein the holes extend through the stiff layer.

5. An interconnect, as set forth in claim 1, wherein the first flexible layer comprises a flexible circuit board.

6. An interconnect, as set forth in claim 1, wherein the first flexible layer comprises Capton.

7. An interconnect, as set forth in claim 1, wherein the plurality of conductive bumps comprise gold.

8. An interconnect, as set forth in claim 1, wherein the plurality of bumps on the first flexible surface have a pitch of 1.0 mm or less.

9. An interconnect, as set forth in claim 1, wherein the plurality of bumps on the first flexible surface have a pitch of less than 2.0 mm.

10. An interconnect, as set forth in claim 1, wherein the plurality of bumps on the first flexible surface have a pitch of less than 5.0 mm.

11. An interconnect, as set forth in claim 1, wherein the signal paths comprise:
vias extending from the first flexible layer to the second flexible layer;
tracings on the first flexible layer connecting the conductive bumps to the vias; and
tracings on the second flexible layer connecting the conductive bumps to the vias.

12. An interconnect, as set forth in claim 11, wherein the signal paths further comprise:
a circuit component interposed between the tracings on the first flexible layer and the tracings on the second flexible layer.

13. An interconnect, as set forth in claim 12, wherein the circuit component is embedded in the stiff layer.

14. An interconnect, as set forth in claim 12, wherein the circuit component includes a resistor.

15. An interconnect, as set forth in claim 12, wherein the circuit component includes a RC network.

16. An interconnect, as set forth in claim 12, wherein the circuit components include a RCR network.

17. A method of making an interconnect, comprising:
bonding a first flexible layer to the first side of the stiff layer;
bonding a second flexible layer to the second side of the stiff layer;
forming a plurality of vias from the first flexible layer to the second flexible layer through the stiff layer;
forming conductive bumps on the first flexible layer, each conductive bump being formed over a hole in the stiff layer and in electrical communication with a via; and
forming conductive bumps on the second flexible layer, each conductive bump being formed over a hole in the stiff layer and in electrical communication with a via where by the conductive bumps formed on the first flexible layer are electrically connected to the conductive bumps formed on the second flexible layer.
